(19) United States
(12) Patent Application Publication
(10) Pub. No.: US 2002/0118634 A1
(43) Pub. Date: Aug. 29, 2002

(54) Rack gear opening mechanism for an optical disk cartridge

(76) Inventor: Hong Khuu, Fremont, CA (US)

Correspondence Address: Bradley J. Bereznak, Blakely, Sokoloff, Taylor & Zafman LLP, Seventh Floor, 12400 Wilshire Boulevard, Los Angeles, CA, 90025-1030, US

(21) Appl. No.: 09/796,852

(22) Filed: Feb. 28, 2001

(51) Int. Cl. G11B 23/03

(52) U.S. Cl. 369/291

(57) ABSTRACT

A rack gear opening mechanism for an optical disk cartridge is provided. As the optical disk cartridge is loaded into a disk drive, a fixed pin in the disk drive is inserted into a housing in the cartridge. The insertion of the fixed pin causes a first gear to move clockwise, a second gear to move counterclockwise, and a third gear to move clockwise. The movement of the third gear clockwise engages a door rack gear attached to a shutter door in the cartridge. The door rack gear slideably moves the shutter door along a rail which opens a window in the cartridge to expose a portion of the optical disk.

### The present invention relates generally to optical disk cartridges and, more particularly, to a rack gear opening mechanism for an optical disk cartridge.

### BACKGROUND

Conventional optical disk cartridges typically include a housing in which an optical disk is accommodated. The housing is provided with a shutter mechanism for protecting the optical disk from exposure when the cartridge is outside an optical disk drive.

The integral components of an optical disk drive include a case, a cartridge loading member, a cartridge loading mechanism, a spindle, and an optical head. The cartridge loading member and the cartridge loading mechanism (generally opening/closing arms pivotally provided at their ends to the optical disk cartridge) are moved between a loaded and a non-loaded state.

One limitation with conventional optical disk cartridges is that they are subjected to contamination due to dust and other particles flowing into the apparatus when the shutter door is open (which exposes both sides of the optical disk through a window in the cartridge). Debris sticks to the optical disk, which may result in errors in recording or regeneration. Another limitation of prior optical disk cartridges is associated with the insertion of the cartridge into the optical disk drive. A relatively high insertion force (i.e., about two pounds) is exerted on the optical disk cartridge as the shutter door is pressed against the cartridge housing. This generates excessive wear and friction, limiting the life expectancy of the optical disk cartridge to about 50,000 cycles (a cycle being the insertion and removal of a cartridge into/out of an optical disk drive) and the life expectancy of the optical disk drive to about 100,000 cycles. Moreover, the movement of the opening/closing arms in the optical disk drive as the cartridge is inserted and removed generates particles after about 100,000 cycles. This, too, limits the life expectancy of the apparatus.

What is needed is an improved optical disk cartridge opening mechanism designed to limit contamination and to decrease the amount of force required to insert the cartridge into an optical disk drive.

### BRIEF DESCRIPTION OF THE DRAWINGS

The present invention is illustrated by way of example, and not limitation, in the figures of the accompanying drawings in which like reference numerals refer to similar elements and which:

FIG. 1A is an exploded view of a portion of a conventional optical disk cartridge as it is inserted into an optical disk drive.

FIG. 1B is an exploded view of the optical disk cartridge of FIG. 1A completely loaded into the optical disk drive.

FIG. 2A is a top perspective view of an optical disk cartridge with the shutter door open according to one embodiment of the present invention.

FIG. 2B is a cutaway view of the optical disk cartridge of FIG. 2A.

FIG. 3 is a view showing both sides of a rack gear opening mechanism for the optical disk cartridge of FIG. 2A.

### DETAILED DESCRIPTION

Throughout the following description specific details are set forth in order to provide a more thorough understanding of the invention. However, the invention may be practiced without these particulars. In other instances, well known elements have not been shown or described in detail to avoid unnecessarily obscuring the present invention. Accordingly, the specification and drawings are to be regarded in an illustrative, rather than a restrictive sense.

The present invention provides for a dual-sided optical disk cartridge containing a rack gear opening mechanism.

According to one embodiment of the present invention, an optical disk cartridge is inserted into an optical disk drive containing a fixed pin. As the cartridge is inserted, the pin is guided through a housing in the cartridge causing a rotational force to be transmitted to three gears (i.e., the rack gear opening mechanism). A first gear moves clockwise, a second gear moves counterclockwise, and a third gear moves clockwise. As the third gear moves clockwise, it engages with a door rack gear attached to a rail in order to linearly advance a cartridge door (i.e., a shutter door) which slides along the rail. In this manner, the shutter door is opened as the cartridge is inserted into the optical disk drive.

According to another embodiment of the present invention, the optical disk cartridge is dual-sided (i.e., it may be inserted into the optical disk drive on either side). Each side of the optical disk cartridge has its own rack gear opening mechanism and housing for the insertion of the fixed pin. When the optical disk cartridge is inserted into the optical disk drive (i.e., when the shutter door is open) only one side of the optical disk is exposed through a window in the cartridge, thus limiting the contamination of the optical disk from particles and extending the life expectancy of the apparatus.

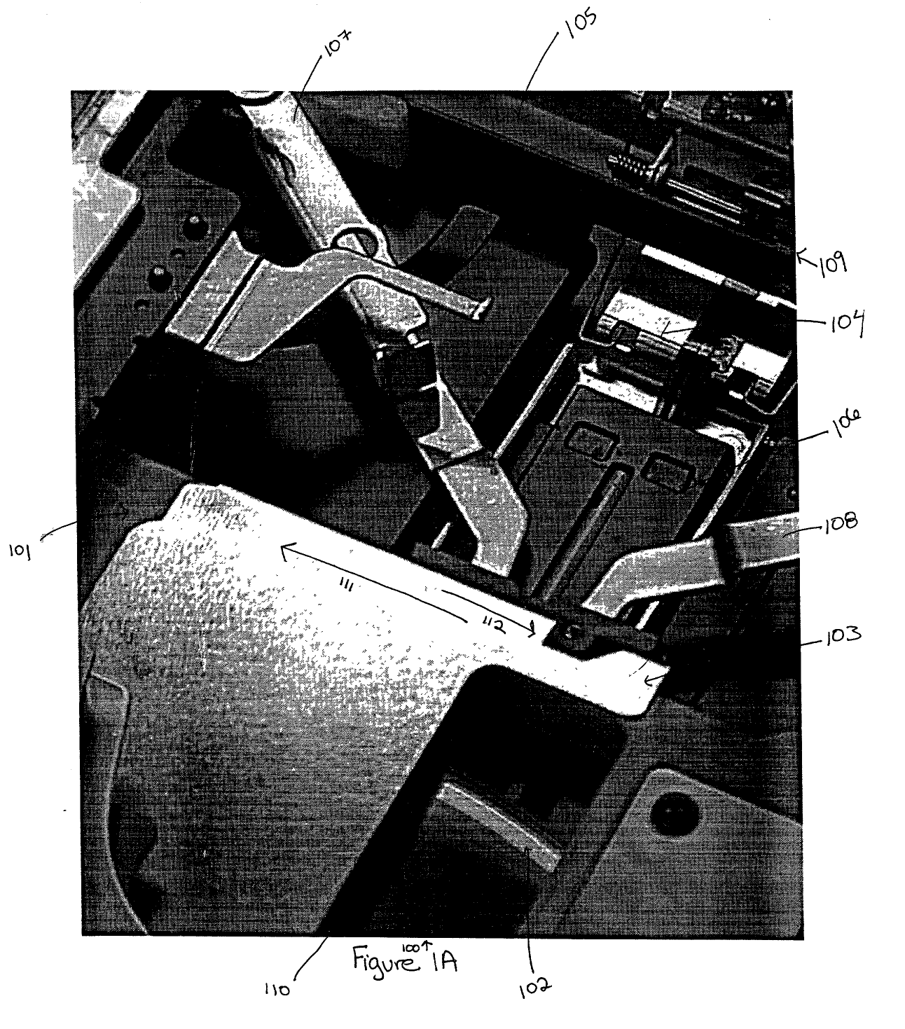

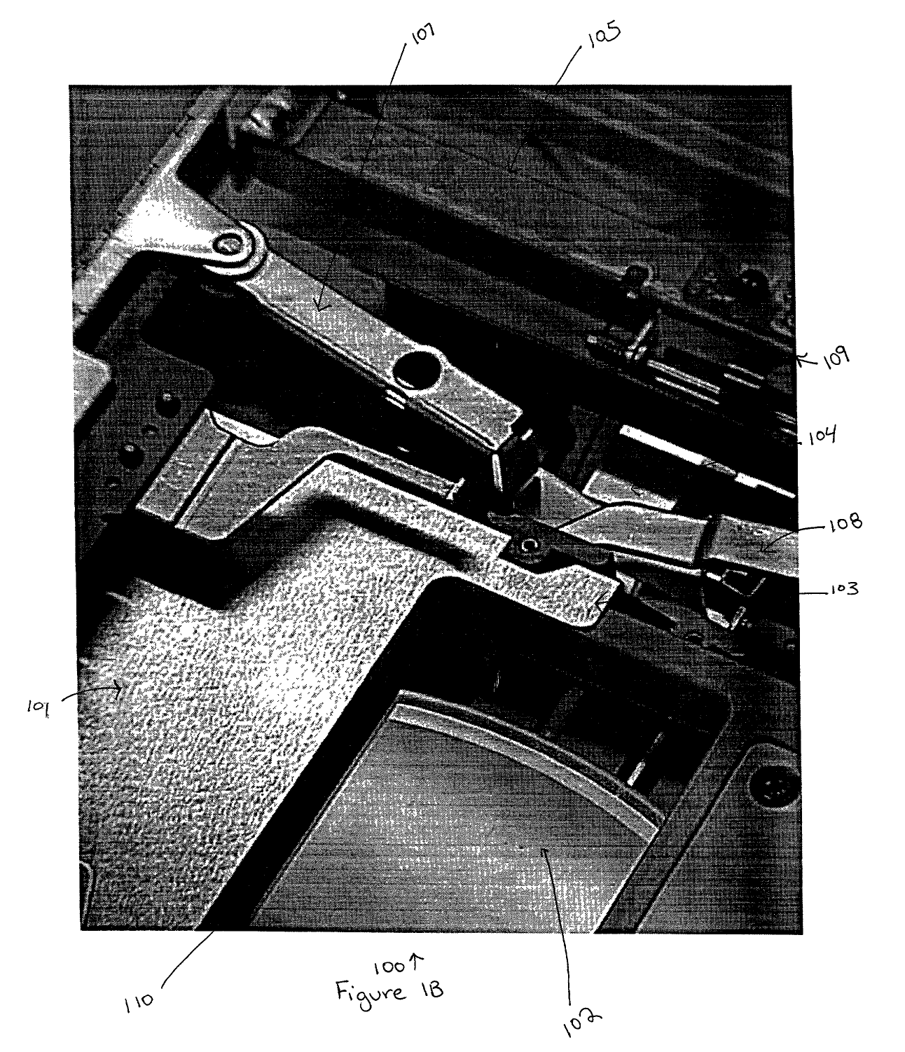

Referring now to FIG. 1A there is shown an exploded view of a portion of a conventional optical disk cartridge as it is inserted into an optical disk drive. The optical disk cartridge 100 includes a cartridge body 101 in which an optical disk 102 is accommodated. The cartridge body 101 includes a shutter door mechanism 103. In the cartridge of FIG. 1, the shutter door 103 is beginning to open as the cartridge 100 is loaded into the optical disk drive 104, exposing a portion of the optical disk 102. The optical disk drive 104 includes a case 105 into which the cartridge body 101 is inserted and has an opening 106 at its bottom through which a turntable may be inserted. Opening/closing arms 107 and 108 are pivotally provided at their ends to side portions on a cartridge stop side 109 of the optical disk drive 104. The opening/closing arms 107 and 108 are affixed to the center of the cartridge body 101 by pins or some other fastening mechanism. The opening/closing arms 107 and 108 are rotated inwardly by the insertion of the optical disk cartridge 100. One of the pins is inserted into a space in the cartridge body 101 defined by a sliding portion of the shutter door 103. Under this condition, when the opening/closing arms 107 and 108 are rotated inwardly the arm 108 affixed to the sliding portion of the shutter door 103 linearly advances the shutter door 103 in an opening direction as indicated by arrow 111 partially opening a window 110 in the cartridge body 101. At the same time, the other pin is not engaged with the shutter door 103 but rides over a front face of the shutter door 103 to slidably move along the front face as indicated by arrow 112. When the cartridge 100 is removed from the optical disk drive 104, the opening/closing arms 107 and 108 are automatically returned back to their original position.

Referring now to FIG. 1B there is shown is an exploded view of the prior art optical disk cartridge of FIG. 1A completely loaded into the optical disk drive. In the view of FIG. 1B, the opening and closing arms 107 and 108 are fully rotated and the optical disk cartridge 100 rests against the cartridge stop side 109 of the optical disk drive 104. The shutter door mechanism 103 is completely open, exposing the optical disk 102 through the window 110. In the loaded state, the optical disk 102 engages with a spindle and revolves within the cartridge body 101. Recording and reproduction of information made on and from the optical disk 102 is made by means of an optical head in the optical disk drive 104.

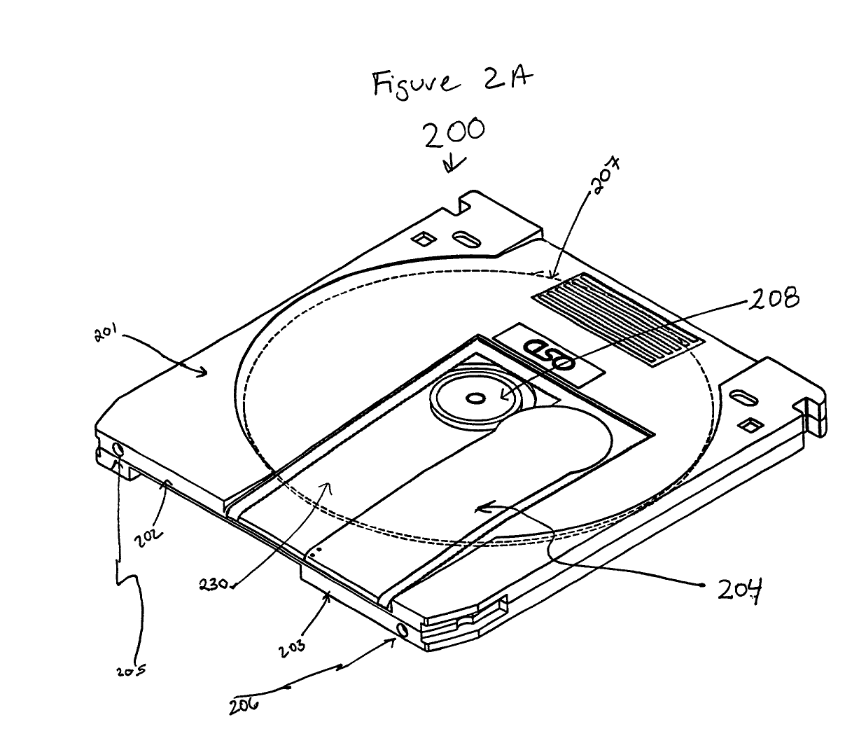

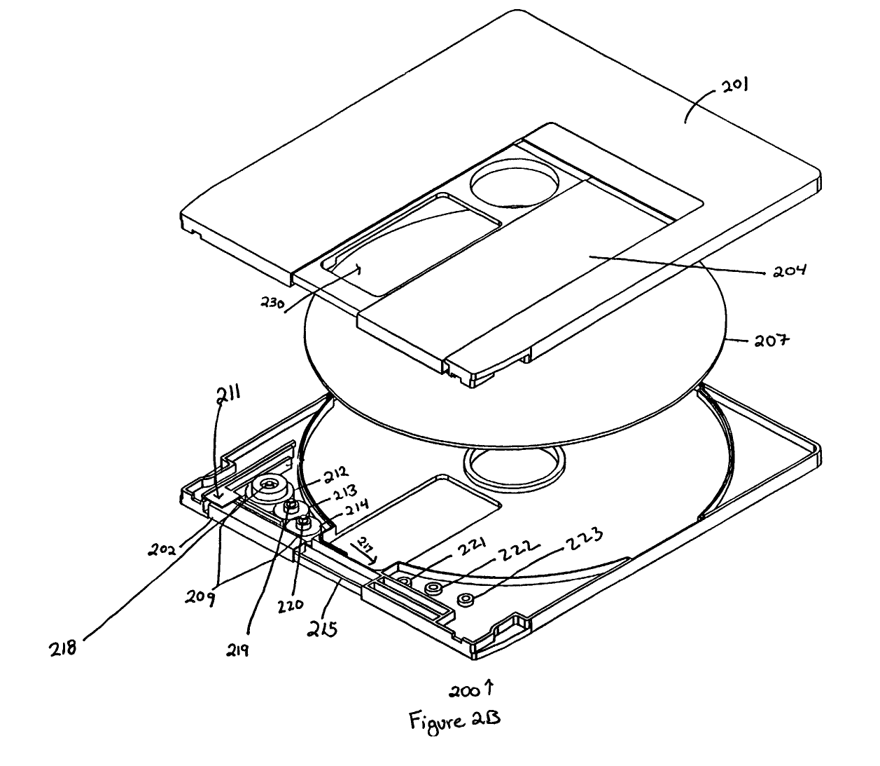

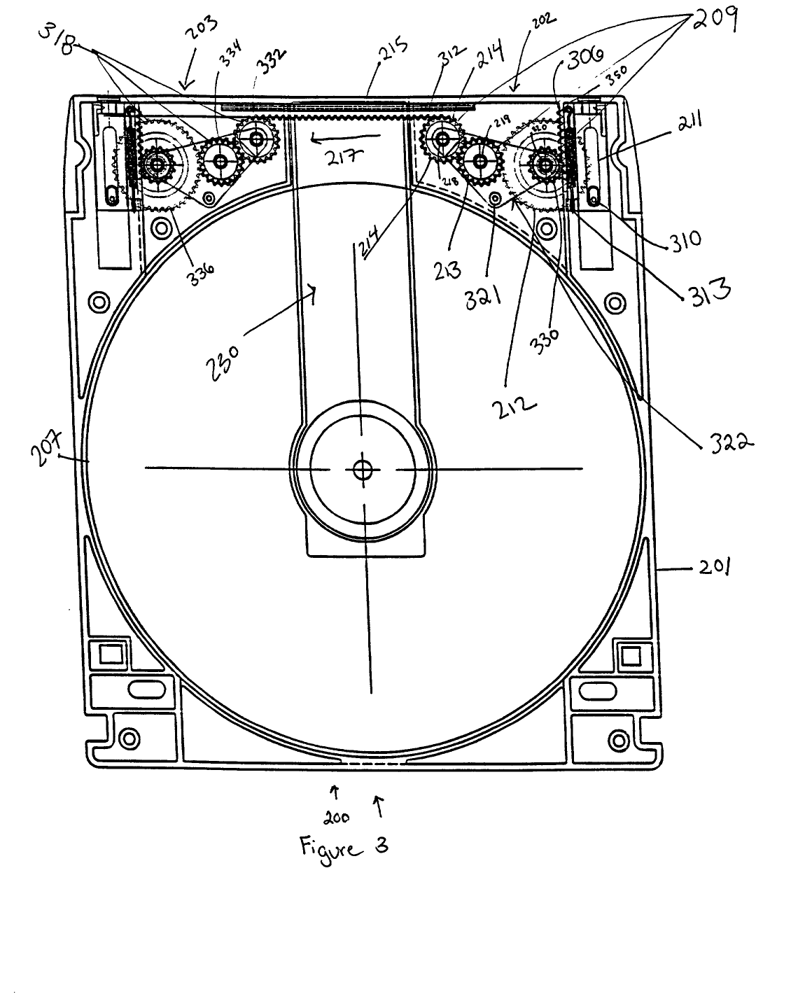

Referring now to FIG. 2A there is shown a top perspective view of an optical disk cartridge with a shutter door open according to one embodiment of the present invention. The optical disk cartridge 200 is composed essentially of a cartridge body 201 made of a hard plastic or some other suitable material. The cartridge body 201 is constructed from a first side 202 and a second side 203 which are bonded together using screws or some other conventional molding/fastening technique well known in the art. The first side 202 and the second side 203 define an enclosure 207 which houses an optical disk (see FIGS. 2B and 3). When inserted into an optical drive, the disk is conventionally mounted on a turntable provided on a spindle motor 208.

A shutter door 204 is slideably mounted on the cartridge body 201. The shutter door 204 is slidingly displaceable to open or close a window 230 so as to allow a reading or writing laser beam within the optical disk drive to impinge on the optical disk. The shutter door 204 may be fabricated from steel or other material known in the art and may be mounted to the cartridge body 201 in a manner also known in the art. In a departure from conventional optical disk cartridges (which typically contain notches located on the side of the cartridge body to engage opening/closing arms in a manner described above), the optical disk cartridge 200 of the present invention includes an insertion hole 205 in the first side 202 and an insertion hole 206 in the second side 203. When the cartridge 200 is inserted into the drive, a fixed pin (see FIG. 3) in the optical disk drive is inserted into either the insertion hole 205 in the first side 202 or the insertion hole 206 in the second side 203, depending on which side of the optical disk cartridge 200 is face up when loaded into the optical disk drive. The insertion of the fixed pin into the insertion hole 205 or 206, triggers a rotational force to be transmitted to a rack gear opening mechanism (see FIGS. 2B and 3) within the cartridge body 201, which opens the shutter door 204 and allows the cartridge 200 to be loaded into the optical disk drive in a manner that will be described in detail herein.

Referring now to FIGS. 2B and 3 there is shown a cutaway view of the optical disk cartridge of FIG. 2A. The rack gear opening mechanism 209 for the first side 202 of the optical disk cartridge 200 comprises a rack and pinion assembly that includes racks 306 and 312 and gear wheels 212, 213, and 214. When the optical disk cartridge 200 is inserted into the optical disk drive, the fixed pin 310 in the optical disk drive is guided through the housing 211 in the cartridge 200. As the pin 310 is guided through the housing 211 it causes the rack gear 306 on the side of the housing 211 to move linearly in relation to the fixed pin 310. The movement of the rack gear 306 causes a rotational force to be transmitted to the rack gear opening mechanism 209. The first gear wheel 212 moves clockwise, causing the second gear wheel 213 to move counterclockwise, and the third gear wheel 214 to move clockwise. As the third gear wheel 214 moves clockwise, it engages with the door rack gear 312 to linearly advance the shutter door 204 which slides along a rail 215 at the front end of the cartridge 200 in the direction of arrow 217. In this manner, the shutter door 204 is opened as the cartridge 200 is inserted into the optical disk drive.

The rack gear opening mechanism 209 is affixed to a retainer plate 322 which is mounted to the cartridge body 201 using screws 218, 219, and 220. Of course, other conventional fastening means known in the art may be used as well. The rack gear opening mechanism 209 is duplicated on the second side 203 of the cartridge 200. In the view of FIG. 2B, the back end of a screw 221 for a first gear wheel 332, a screw 222 for a second gear wheel 334, and a screw 223 for a third gear wheel 336 of a rack gear opening mechanism 318 on the second side 203 of the optical disk cartridge 200 are shown. The screws 221, 222, and 223 are used to affix the rack gear opening mechanism 318 on the second side 203 of the cartridge 200 to the cartridge body 201. Because of the dual-sided nature of the optical disk cartridge 200 of the present scheme, when the rack gear opening mechanism 209 opens the shutter door 204, the window 230 exposes the optical disk 207 on one side only. Thus, the optical disk 207 is afforded more protection from debris and other particles than with conventional optical disk cartridges (which expose the optical disk through a window on both sides of the optical disk when the shutter door is open).

Referring now to FIG. 3 there is shown a view of both sides of a rack gear opening mechanism for the optical disk cartridge of FIG. 2A. In operation, the front face of the rack gear opening mechanism 209 for the first side 202 faces an opposite direction than that of the front face of the rack gear opening mechanism 318 for the second side 203, so that either side 202 or 203 of the optical disk cartridge 200 may be inserted face-up into the optical disk drive.

In the embodiment illustrated by FIG. 3, the optical disk cartridge 200 is in the loaded state. As described above, the third gear 214 engages a door rack gear 312 affixed to the rail 215 at the front end of the optical disk cartridge 200. The shutter door 204 is affixed to the rail 215 using pins or some other conventional fastening means. The door 204 is slideably moved along the surface of the cartridge body 201 when the fixed pin 310 in the optical disk drive is inserted into the housing 211 causing the rack gear 306 (which is held in place by a spring 313) to transmit a rotational force to the rack gear opening mechanism 209 which is attached to the retainer plate 322 using a bolt 321 (or some other conventional fastening means) affixed to the cartridge body 201. As is shown in the view illustrated by FIG. 3, the rack gear 306 on the side of the housing 211 and the door rack gear 312 include teeth that engage the teeth of the gear wheels (or pinions) 212, 213, and 214. The first gear wheel 212 includes an inner wheel 330 of teeth that engages the rack gear 306 and an outer wheel of teeth that engages the second gear wheel 213. The teeth of the second gear wheel 213 engage the teeth of the third gear wheel 214. The teeth of the third gear wheel 214 engage corresponding teeth on the door rack gear 312. The rack gear 306 and 312 ratio is set by the diameter ratio of the first gear wheel 212 and the third gear wheel 214 so as to fully open the shutter door 204. Translating motion of the rack gear 306 affixed to the housing 211 is a sliding bar 350 which slides in a first direction upon the insertion of the fixed pin 310. The rotational force causes the first gear 212 to rotate clockwise, causing the second gear 213 to rotate counterclockwise, causing the third gear 214 to rotate clockwise and engage the door rack gear 312. This causes the shutter door to slide in a transverse direction along the side of the cartridge body 201 orthogonal to the direction of the insertion of the fixed pin 310 as the teeth of the third wheel 214 engage the teeth of the door rack gear 312. The optical disk 207 is exposed through a window 230 when the cartridge 200 is in the loaded state (and the shutter door 204 is fully open) to enable an optical head in the optical disk drive to record or reproduce information from the optical disk 207.

It should be appreciated that the components of the first side 202 of the optical disk cartridge 200 are duplicated on the second side 203 and that the rack gear opening mechanism 209 of side 202 functions in exactly the same capacity as the rack gear opening mechanism 318 of side 203. In this manner, the optical disk cartridge 200 may be inserted with either side face-up into the optical disk drive. This provides an advantage to the user (generally a human operator) in that no time is wasted determining which side of the optical disk cartridge 200 to load into the optical disk drive. Another advantage of the present scheme is that the force required to insert the optical disk cartridge 200 into the optical disk drive is less than a ½ pound, which is much less than the 2 pound force normally required to insert conventional optical disk cartridges (i.e., those with opening/closing arms) into an optical disk drive. Thus, there is much less wear and friction placed on both the optical disk cartridge 200 and the optical disk drive, which greatly extends the life expectancy of these devices.

Thus, a rack gear opening mechanism for an optical disk cartridge has been described. Although the foregoing description and accompanying figures discuss and illustrate specific embodiments, it should be appreciated that the present invention is to be measured only in terms of the claims that follow.

What is claimed:

1. An optical disk cartridge, comprising:
a body housing an optical disk, the body having an opening on a side to accept a pin of an optical disk drive when the optical disk cartridge is inserted into the drive;
a rack slideably mounted to a side of the body;
a shutter door affixed to the rack, the shutter door opening to expose the optical disk when the rack slides in a transverse direction; and
a rack gear mechanism configured to slide the rack in the transverse direction upon insertion of the pin into the opening.

2. The optical disk cartridge of claim 1,wherein the rack gear mechanism is comprised of three gear wheels mounted to a retainer plate in the cartridge body.

3. The optical disk cartridge of claim 1 wherein the insertion of the pin into the opening causes a first gear wheel to move in a first rotational direction, a second gear wheel to move in a second rotational direction opposite to the first rotational direction, and a third gear wheel to move in the first rotational direction.

4. The optical disk cartridge of claim 3 wherein the first gear wheel includes an inner wheel of teeth that engage a rack on the side of the opening and an outer wheel of teeth that engage teeth on the second gear wheel.

5. The optical disk cartridge of claim 4 wherein the teeth of the second gear wheel engage teeth of the third gear wheel.

6. The optical disk cartridge of claim 5 wherein the teeth of the third gear wheel engage corresponding teeth on a door rack gear causing the door rack gear to slideably move the shutter door.

7. The optical disk cartridge of claim 6 wherein a rack gear ratio is set by the diameter of the first gear wheel and the third gear wheel so as to fully open the shutter door to expose the optical disk.

8. The optical disk cartridge of claim 1 wherein the cartridge is divided into a first side and a second side, each side containing its own rack gear mechanism, shutter door, and housing for the pin.

9. The optical disk cartridge of claim 1 wherein the disk cartridge may be loaded into the optical disk drive with either side face-up.

10. A dual-sided optical disk cartridge, each side comprising:
a body housing an optical disk, the body having an opening on a side to accept a pin of an optical disk drive when the optical disk cartridge is inserted into the drive;
a rack slideably mounted to a side of the body;
a shutter door affixed to the rack, the shutter door opening to expose the optical disk when the rack slides in a transverse direction; and a rack gear mechanism configured to slide the rack in the transverse direction upon insertion of the pin into the opening.

11. The optical disk cartridge of claim 10 wherein the rack gear mechanism is comprised of three gear wheels mounted to a retainer plate in the cartridge body.

12. The optical disk cartridge of claim 11 wherein the insertion of the pin into the opening causes a first gear wheel to move in a first rotational direction, a second gear wheel to move in a second rotational direction opposite to the first rotational direction, and a third gear wheel to move in the first rotational direction.

13. The optical disk cartridge of claim 12 wherein the first gear wheel includes an inner wheel of teeth that engage a rack on the side of the opening and an outer wheel of teeth that engage teeth on the second gear wheel.

14. The optical disk cartridge of claim 13 wherein the teeth of the second gear wheel engage teeth of the third gear wheel.

15. The optical disk cartridge of claim 14 wherein the teeth of the third gear wheel engage corresponding teeth on a door rack gear causing the door rack gear to slideably move the shutter door.

16. The optical disk cartridge of claim 15 wherein a rack gear ratio is set by the diameter of the first gear wheel and the third gear wheel so as to fully open the shutter door to expose the optical disk.

17. The optical disk cartridge of claim 10 wherein the cartridge may be loaded into the optical disk drive with either side face-up.

18. A method, comprising:
providing an optical disk cartridge including a body housing an optical disk, the body having an opening on a side to accept a pin of an optical disk drive when the optical disk cartridge is inserted into the drive;
providing a rack slideably mounted to a side of the body;
affixing a shutter door to the rack, the shutter door opening to expose the optical disk when the rack slides in a transverse direction; and
providing a rack gear mechanism configured to slide the rack in the transverse direction upon insertion of the pin into the opening.

19. The method of claim 18 wherein the rack gear mechanism is comprised of three gear wheels mounted to a retainer plate in the cartridge body.

20. The method of claim 18 wherein the insertion of the pin into the opening causes a first gear wheel to move in a first rotational direction, a second gear wheel to move in a second rotational direction opposite to the first rotational direction, and a third gear wheel to move in the first rotational direction.

21. The method of claim 18 further comprising providing an inner wheel of teeth in the first gear wheel that engage a rack on the side of the opening and an outer wheel of teeth that engage teeth on the second gear wheel.

22. The method of claim 21 wherein the teeth of the second gear wheel engage teeth of the third gear wheel.

23. The method of claim 22 wherein the teeth of the third gear wheel engage corresponding teeth on a door rack gear causing the door rack gear to slideably move the shutter door.

24. The method of claim 23 further comprising providing a rack gear ratio set by the diameter of the first gear wheel and the third gear wheel so as to fully open the shutter door to expose the optical disk.

25. The method of claim 18 wherein the optical disk cartridge is divided into a first side and a second side, each side containing its own rack gear mechanism, shutter door, and housing for the pin.
